(19) United States
(12) Patent Application Publication
(10) Pub. No.: US 2013/0175773 A1
(43) Pub. Date: Jul. 11, 2013

(54) DECK ASSEMBLY FOR A SKATEBOARD

(71) Applicants: Todd Colin Sherley, Burleigh Heads (AU); Christian McEwon, Palm Beach (AU)

(72) Inventors: Todd Colin Sherley, Burleigh Heads (AU); Christian McEwon, Palm Beach (AU)

(21) Appl. No.: 13/339,670

(22) Filed: Dec. 29, 2011

(30) Foreign Application Priority Data
Dec. 29, 2010 (AU) 2010905698
Oct. 19, 2011 (AU) 2011904332

(51) Int. Cl. A63C 17/01; F16B 33/00; B23P 11/00

(52) U.S. Cl. CPC A63C 17/01; B23P 11/00; F16B 33/00
USPC 280/11.19; 29/525.02; 411/366.1

(57) ABSTRACT

A deck assembly for a skateboard includes a deck that defines a pair of sets of passages corresponding with openings in mounting structures used for mounting trucks to the deck. A number of male connectors correspond with respective passages and openings, each male connector having an externally threaded shank, a head on a distal end of the shank and a tool engaging formation defined on a proximal end of the shank. A number of female connectors correspond with respective passages and openings, each female connector defining an internally threaded barrel, open at both ends, and a flange on a proximal end of the barrel. The shank is configured for threaded engagement with the barrel, using a tool that engages the formation through the female connector, the female connectors being received through the passages and openings such that the heads of the female connectors bear against the deck and the male connectors being received through the openings and into the passages to engage respective barrels such that the tool engaging formations can be accessed from an operatively upper side of the deck allowing the mounting structures to be secured to the deck from said upper side.

### PRIORITY TO FOREIGN APPLICATIONS

This application claims priority under 35 U.S.C. §119 to the following Australian Patent Applications each of which is incorporated herein by reference in their entirety for the purpose of enablement and written description: Australian Patent Application 2010905698 filed Dec. 29, 2010 and Australian Patent Application 2011904332 filed Oct. 19, 2011.

### FIELD OF THE INVENTION

This invention relates to a deck assembly for a skateboard. The invention also relates to, but is not limited to, a fastener suitable for the deck assembly and to a method of assembling a skateboard.

### BACKGROUND OF THE INVENTION

A common example of a truck of a skateboard usually has a base plate that is fastened to an underside of the deck of the skateboard. A riser pad can be interposed between the base plate and the deck. A threaded kingpin can extend from the base plate and through a flexible bushing. The kingpin can extend through a hanger, a cone bushing and a top cup washer. A kingpin nut can be fastened to the kingpin thus securing the hanger to the base plate, with the bushings providing flexibility of movement.

A pivot arm can extend from the hanger and can be received in a pivot cup defined by the base plate. A pivot bushing can be interposed between the pivot arm and the pivot cup. These components constrain movement of the hanger to pivotal movement in a generally vertical plane. An axle extends from each side of the hanger so that bearings and wheels can be mounted on the truck.

Trucks require regular replacement, particularly when skateboards are used by enthusiasts and professionals. Replacement may be for the purposes of changing the performance characteristics or even as a result of wear and tear.

Presently, conventional fastening arrangements are used to secure the base plate to the deck. For this purpose, the base plate usually has four openings, one at each corner, through which a shank of a bolt or screw is received from an upper side of the deck. Thus, the deck, or more particularly the core, has four bores or passages that correspond with the openings in the base plate. The fastening arrangement can include bolts or screws that extend through the deck and through the openings in the base plate. Heads of the bolts or screws are accessible from the upper side of the deck and nuts can be screwed onto shanks of the bolts or screws.

The heads of the bolts or screws can be received through bores drilled through the core. Usually, the core is covered with a layer of grip tape. The grip tape is then pierced to provide access to the bores and the bolts or screws inserted through the pierced openings into the bores. When the bolts or screws are tightened, the grip tape can be damaged by the heads turning against the grip. Since the nuts usually contain some form of locking material, it is necessary to rotate the heads to achieve fastening. This can reduce the aesthetic appeal and efficacy of the grip tape and thus of the deck itself.

If a nut needs to be screwed onto the shank, it is usually necessary for a pair of tools to be used to engage both the head and the nut so requiring a user to work on both sides of the deck in order to fasten the truck to the deck. This also requires that the nut be a conventional nut which can have limited aesthetic appeal.

### SUMMARY OF THE INVENTION

According to a first aspect of the invention, there is provided a deck assembly for a skateboard, the deck assembly comprising

a deck that defines a pair of sets of passages corresponding with openings in mounting structures used for mounting trucks to the deck;
a number of male connectors corresponding with respective passages and openings, each male connector having an externally threaded shank, a head on a distal end of the shank and a tool engaging formation defined on a proximal end of the shank; and
a number of female connectors also corresponding with respective passages and openings, each female connector defining an internally threaded barrel, open at both ends, and a flange on a proximal end of the barrel, the shank being configured for threaded engagement with the barrel, using a tool that engages the formation through the female connector, the female connectors being received through the passages and openings such that the heads of the female connectors bear against the deck and the male connectors being received through the openings and into the passages to engage respective barrels such that the tool engaging formations can be accessed from an operatively upper side of the deck allowing the mounting structures to be secured to the deck from said upper side.

A thread lock may be arranged on at least one of the barrel and the shank to lock the barrel and shank together when the male and female connectors are fastened together.

A layer of grip tape may be positioned on the deck so that, as the male and female connectors are fastened together, a portion of the grip tape is interposed between the flange of the female connector and the deck.

The thread lock may be in the form of an insert of a locking material positioned on an internal surface of the barrel at the proximal end, the locking material being softer than the material of the male connector, permitting a proximal portion of the thread of the shank to cut into the locking material, thereby securing the shank against subsequent un-threading.

The thread lock may be a strip of locking material arranged about the shank of the male connector, proximate the head of the male connector so that, as the shank screwed into the barrel, the thread in the barrel can engage the locking material to lock the shank in the barrel.

The thread lock may be an O ring located at the proximal end of the barrel, the barrel defining a circumferential recess in which the O ring is located and the recess and corresponding O-ring are such that a proximal portion of the shank deforms the O-ring as the shank is screwed into the barrel, the O-ring being dimensioned so that the deformation combined with the resilience of the O-ring serves to secure the shank against subsequent un-threading.

The locking means may be in the form of a series of axially extending ridges extending from an end of the internal thread of the barrel to the proximal end of the barrel. The shank of the male connector may define a proximal portion that is un-threaded and that is configured to interfere with the ridges as the shank is secured to the barrel. The ridges may be configured so that as the proximal portion of the shank passes beyond the internal thread of the barrel, the proximal portion engages the ridges to retain the shank in position and to secure the shank against subsequent un-threading.

The internal thread of the barrel may have a profile that defines a ramped surface between a pair of apices, one deeper than the other so that an apex of the male thread initially bears against the ramped surface before being driven towards the deeper apex as the shank is tightened so locking the shank in the barrel.

The deck assembly may include a core that defines the passages, the core being of a material that is softer than that of the female connector, the flange of the female connector tapering outwardly towards a proximal end such that when the shank of the male connector is tightened into the barrel of the female connector, the flange, with a portion of the grip tape, sinks into the core such that the associated passage becomes counter-sunk.

A tapered surface of the flange may include at least one gripping formation to engage the core to inhibit rotation of the female connector when the male connector is tightened into the barrel of the female connector.

A head of the male connector may be configured to be engaged with a suitable tool, such as a conventional spanner or insertion key with any number of sides, such as three sides for a triangular key or six sides, as with a hex key.

The head of the male connector may have a thickness of between approximately 1 mm and 3 mm so as to define a suitably low profile to minimise interference of the mounting structure with surfaces on which the skateboard is used.

The mounting structures may be in the form of base plates, each base plate having a number of openings to allow the base plate to be fastened to the deck with a corresponding number of the male and female connectors.

The barrels of the female connectors may be dimensioned so that when they are positioned in the passages, they extend from a lower surface of the deck to be received partially in respective openings in the base plate, so serving to locate the base plates correctly prior to engagement of the male connectors with the female connectors.

According to a second aspect of the invention, there is provided a method of assembling a skateboard, the method comprising the steps of:
positioning barrels of each of a number of female connectors in respective passages defined in a deck of the skateboard, each barrel being internally threaded, open at both ends and having a flange on a proximal end of the barrel;
positioning externally threaded shanks of each of a number of corresponding male connectors in openings in mounting structures used for mounting trucks to the deck, the shanks being configured for threaded engagement with respective barrels and having tool engaging formations defined on their proximal ends and heads on their distal ends to engage operatively lower surfaces of the mounting structures; and
fastening the mounting structures to the deck by threading the male connectors onto the female connectors with a tool that accesses the tool engaging formations from a proximal end of the female connectors.

The deck of the skateboard may include a layer of grip tape positioned on a core of the deck, the method including the steps of punching openings in the grip tape corresponding with the respective passages and inserting the barrels into the passages so that portions of the grip tape are interposed between the flanges and the core.

According to a third aspect of the invention, there is provided a fastener for use with a deck assembly of a skateboard, the fastener comprising
a male connector having an externally threaded shank, a head on a distal end of the shank and a tool engaging formation defined on a proximal end of the shank, the male connector capable of being received through an opening defined in a mounting structure for mounting a truck to a deck of the skateboard with the head engaging an operatively lower surface of the mounting structure; and
a female connector defining an internally threaded barrel that is capable of being received in a passage defined in the deck and corresponding to the opening in the mounting structure, the barrel being open at both ends, and a flange being positioned on a proximal end of the barrel, the shank being configured for threaded engagement with the barrel, using a tool that engages the formation through the female connector.

According to a fourth aspect of the invention, there is provided a fastener that comprises
a male connector having an externally threaded shank, a head on a distal end of the shank and a tool engaging formation defined on a proximal end of the shank; and
a female connector defining an internally threaded barrel, open at both ends, and a head on a proximal end of the barrel, a locking means being arranged within the barrel at the proximal end, the shank being configured for threaded engagement with the barrel and for engagement with the locking means, using a tool that engages the formation through the female connector.

The head of the male connector may be of any suitable configuration. For example, the head may be shaped to engage a suitable tool, such as a spanner or key. In one embodiment, the head may be disc-shaped and may define a series of axially extending ridges to facilitate a thumb grip. The head can be configured to have a shape that is free of constraints that would be required were the head required to be engaged with a tool or even the fingers. For example, the head could be of a relatively small thickness to as to define a low profile in certain applications. In particular, the head could be relatively thin and flange-like to sit substantially flat against a component.

The head of the female connector can also be of any suitable configuration. For example, the head of the female connector could be in the form of a flange.

Thus, both the head of the male connector and the flange of the female connector could have a thickness which is such that the fastener defines a low profile on respective sides of components being fastened together.

The tool engaging formation of the shank may be configured so that a conventional tool can be used to rotate the male connector. In one embodiment, the tool engaging formation is in the form of a socket defined in the proximal end. For example, the socket may be shaped so that a key can engage the shank Instead of a socket, the tool engaging formation may be configured so that a screwdriver can be used to rotate the male connector.

In one embodiment, the locking means may be in the form of an insert of a locking material positioned on an internal surface of the barrel at the proximal end. The locking material may be softer than the material of the male connector, permitting a proximal portion of the thread of the shank to cut into the locking material thereby securing the shank against subsequent un-threading. Thus, when the shank of the male connector is threaded into the barrel, the shank can engage the layer of locking material to provide a locking effect. The locking material can be in the form of any number of materials including metals and plastics.

In another embodiment, the locking means may be in the form of a strip of locking material wrapped around the shank of the male connector, proximate the head of the male connector. Instead of being wrapped around the shank, the locking material may be in the form of a band of the material that is located in a slot or groove formed in the shank, proximate the head of the male connector. Thus, as the shank is screwed into the barrel, the thread in the barrel can engage the locking material to lock the shank in the barrel.

The internal surface of the barrel may define a lip at the proximal end. The lip may be configured to retain the insert in position while the male connector is screwed into operative engagement with the female connector. Furthermore, it may be positioned to stop over-threading of the male connector thereby preventing the male connector from extending proud of the proximal end of the female connector.

In another embodiment, the locking means may be in the form of an O-ring located at the proximal end of the barrel. The barrel may define a circumferential recess in which the O-ring is located. The position of the recess and corresponding O-ring may be such that a proximal portion of the shank deforms the O-ring as the shank is screwed into the barrel. The O-ring is dimensioned so that such deformation combined with the resilience of the O-ring serves to secure the shank against subsequent un-threading.

In yet another embodiment, the locking means may be in the form of a series of axially extending ridges extending from an end of the internal thread of the barrel to the proximal end of the barrel.

In this embodiment, the shank of the male connector may define a proximal portion that is unthreaded and that is configured to interfere with the ridges as the shank is secured to the barrel. The ridges may be configured so that as the proximal portion of the shank passes beyond the internal thread of the barrel, the proximal portion engages the ridges to retain the shank in position and to secure the shank against subsequent un-threading.

The proximal portion of the shank may be defined by a polygonal wall with outer corners. The wall may be dimensioned so that the corners engage the ridges in a manner that relies on the material of the female connector and the dimensions of the individual ridges. For example, the engagement can be ratchet-fashion or as a result of deformation of the ridges. The wall may be hexagonal so that an inner surface of the wall can engage a tool, such as an Allen key.

In a further embodiment, the internal thread of the barrel can be configured so that the shank is effectively retained against un-threading once the shank is tightened into the barrel. In particular, the internal thread of the barrel can have a profile that defines a ramped surface between a pair of apices, one deeper than the other. An apex of the male thread initially bears against the ramped surface before being driven towards the deeper apex as the shank is tightened. This serves to lock the shank into the barrel.

The fastener of the invention finds particular application for fastening a truck of a skateboard to a deck of the skateboard.

In that application, a number of the fasteners may be used to secure a truck to the deck. For example, four fasteners can be used for a conventional truck.

The barrel of each fastener may be positioned in a respective passage drilled through a core of the deck. The flange may have a profile shaped so that, when the shank is tightened into the barrel, the flange sinks into the core such that the passage becomes counter-sunk and the flange is flush with an upper side of the core. It follows that the flange can be covered with the grip tape that can be pierced to define openings only large enough to correspond with the tool used to engage the shank of the male connector. It will be appreciated that since it is just the shank that rotates, there is no screw or bolt head to damage the grip tape in the event that the trucks need replacing.

According to a fifth aspect of the invention, there is provided a skateboard that comprises
a deck assembly of the first aspect of the invention; and
a pair of trucks fast with the deck assembly, mounting structures of the trucks secured to the deck with the male connectors engaged with the female connectors in the manner described above to the fasten mounting structures of the trucks to the deck.

The mounting structures may be base plates of the trucks so that the base plates are sandwiched between the heads of the male or female connectors and the deck.

The relative dimensions of the male and female connectors may be selected so that the shank of the male connector engages the locking means or thread lock arranged within the female connector to secure the male connector against subsequent un-threading.

The inventors envisage that the heads of the male connectors do not necessarily have to bear directly against the base plate. Thus, a clamp or the like can be used to clamp the base plate to the deck with at least the shanks of the male connector or the barrels of the female connectors being positioned in respective openings or corresponding formations in the clamp.

The invention is now described, by way of examples, with reference to the accompanying drawings. The following description is for the purpose of illustrating the manner in which the invention can be put into practice. As such, the following description is not intended to limit the scope of the preceding paragraphs or the appended claims

### DESCRIPTION OF THE DRAWINGS

FIG. 1 shows a side view of a first embodiment of a fastener, in accordance with the invention suitable for fastening a truck of a skateboard to a deck of the skateboard.

FIG. 2 shows a three-dimensional view of the fastener of FIG. 1.

FIG. 3 shows a side sectioned view of the fastener of FIG. 1 in a disassembled condition.

FIG. 4 shows a side sectioned view of the fastener of FIG. 1 in a partially assembled condition.

FIG. 5 shows a side sectioned view of the fastener of FIG. 1 in a secured, operative condition.

FIG. 6 shows a side view of a second embodiment of a fastener, in accordance with the invention.

FIG. 7 shows a three-dimensional view of the fastener of FIG. 6.

FIG. 8 shows a side sectioned view of the fastener of FIG. 6 in a disassembled condition.

FIG. 9 shows a side sectioned view of the fastener of FIG. 6 in a partially assembled condition.

FIG. 10 shows a side sectioned view of the fastener of FIG. 6 in a secured, operative condition.

FIG. 11 shows a side sectioned view of a third embodiment of a fastener, in a disassembled condition.

FIG. 12 shows a side sectioned view of the fastener of FIG. 11 in a partially assembled condition.

FIG. 13 shows a side sectioned view of the fastener of FIG. 11 in a secured, operative condition.

FIG. 14 shows a side view of a fourth embodiment of a fastener, in accordance with the invention, in a disassembled condition.

FIG. 15 shows a three-dimensional view of the fastener of FIG. 14.

FIG. 16 shows a schematic, exploded side view of a deck assembly, in accordance with the invention of a skateboard, incorporating fasteners, each also in accordance with the invention.

FIG. 17 shows an underneath view of the deck assembly of FIG. 16 in an assembled condition.

FIG. 18 shows a female connector of the fastener of FIGS. 1 and 2.

FIG. 19.1 shows a disassembled view of the fastener of FIGS. 1 and 2.

FIG. 19.2 shows an underneath view of a flange of the female connector.

FIG. 20 shows a schematic side sectioned view of an initial fastening stage using the fastener of FIG. 18.

FIG. 21 shows a schematic side sectioned view of the fastener of FIG. 18, in use.

FIG. 22 shows a female connector of the fastener of FIGS. 6 to 10.

FIG. 23.1 shows a disassembled view of the fastener of FIGS. 6 to 10.

FIG. 23.2 shows an underneath plan view of the flange of the female connector.

FIG. 24 shows a schematic side sectioned view of an initial fastening stage using the fastener of FIGS. 6 to 10.

FIG. 25 shows a schematic side sectioned view of the fastener of FIG. 22, in use.

FIG. 26 shows a side view of a fifth embodiment of a fastener, in accordance with the invention, in an assembled condition.

FIG. 27.1 shows a disassembled view of the fastener of FIG. 26.

FIG. 27.2 shows an underneath plan view of the flange of the female connector.

FIG. 28 shows a schematic side sectioned view of an initial fastening stage using the fastener of FIG. 26.

FIG. 29 shows a schematic side sectioned view of the fastener of FIG. 26, in use.

FIG. 30.1 shows a side view of a sixth embodiment of a fastener, in accordance with the invention.

FIG. 30.2 shows detail of the threads of the male and female connectors of the fastener of FIG. 30.1.

FIG. 31.1 shows a disassembled view of the fastener of FIG. 30.1.

FIG. 31.2 shows an underneath plan view of the flange of the female connector.

FIG. 32 shows a schematic side sectioned view of an initial fastening stage using the fastener of FIG. 30.1.

FIG. 33 shows a schematic side sectioned view of the fastener of FIG. 30, in use.

FIG. 34 shows a side view of a seventh embodiment of a fastener, in accordance with the invention.

FIG. 35.1 shows a disassembled view of the fastener of FIG. 34.

FIG. 35.2 shows an underneath plan view of the flange of the female connector.

FIG. 36 shows a schematic side sectioned view of an initial fastening stage using the fastener of FIG. 34.

FIG. 37 shows a schematic side sectioned view of the fastener of FIG. 34, in use.

FIG. 38 shows a side view of an eighth embodiment of a fastener, in accordance with the invention.

FIG. 39.1 shows a disassembled view of the fastener of FIG. 38.

FIG. 39.2 shows an underneath plan view of the flange of the female connector.

FIG. 40 shows a schematic side sectioned view of an initial fastening stage using the fastener of FIG. 38.

FIG. 41 shows a schematic side sectioned view of the fastener of FIG. 38, in use.

### DESCRIPTION OF THE EMBODIMENTS

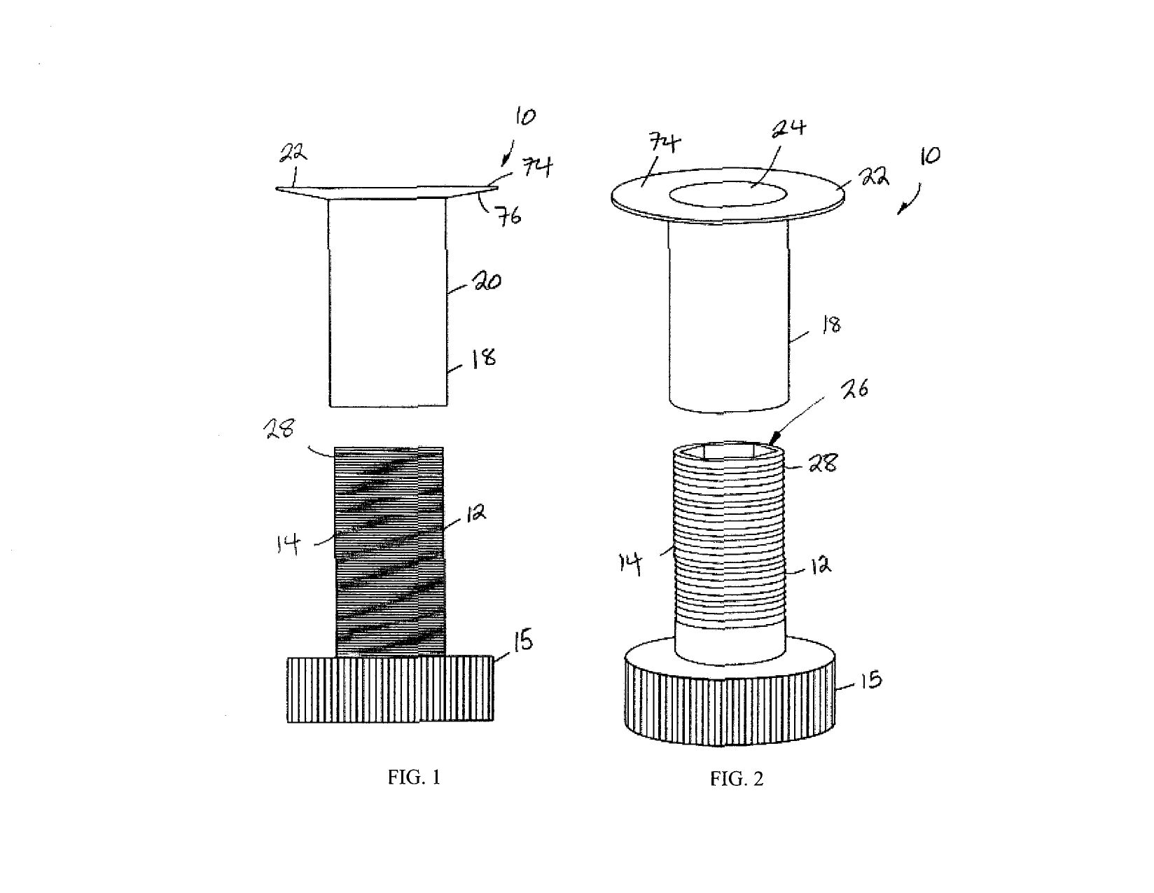

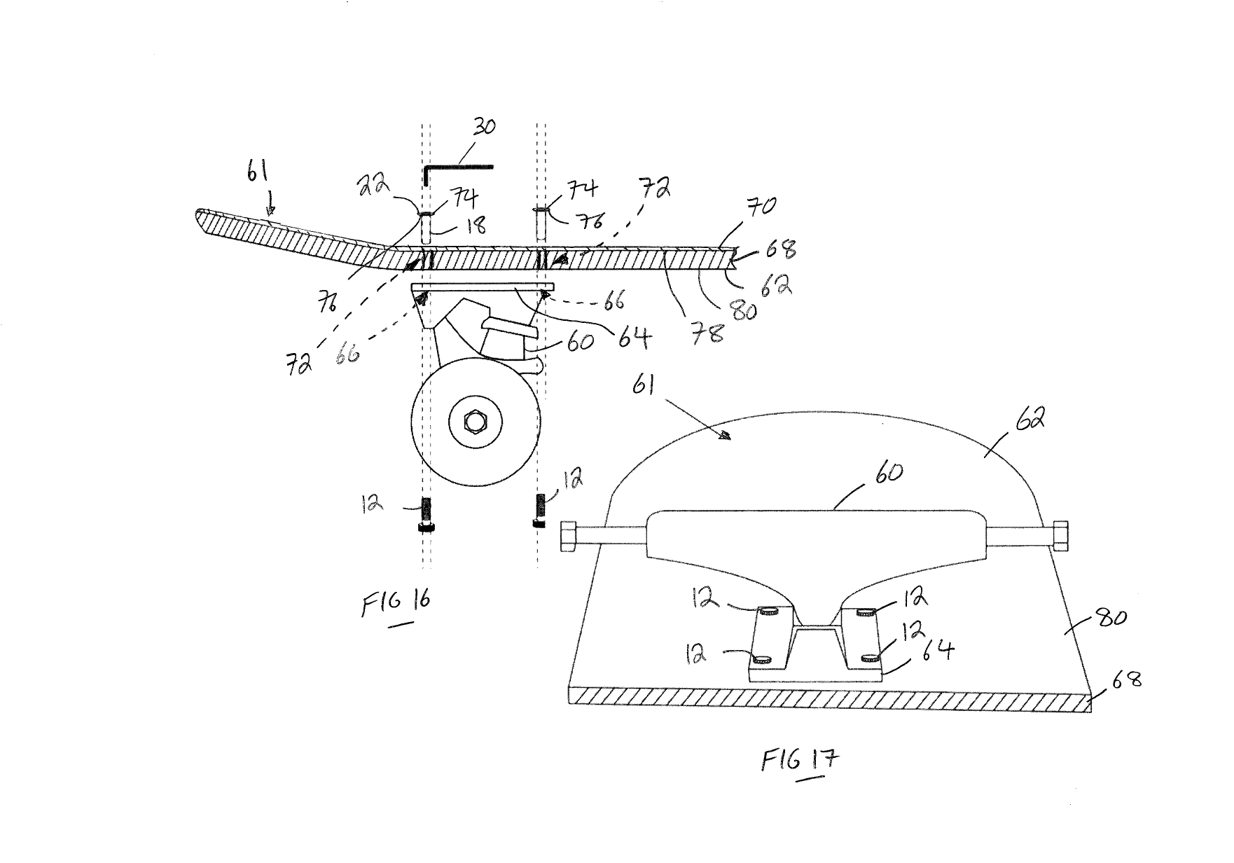

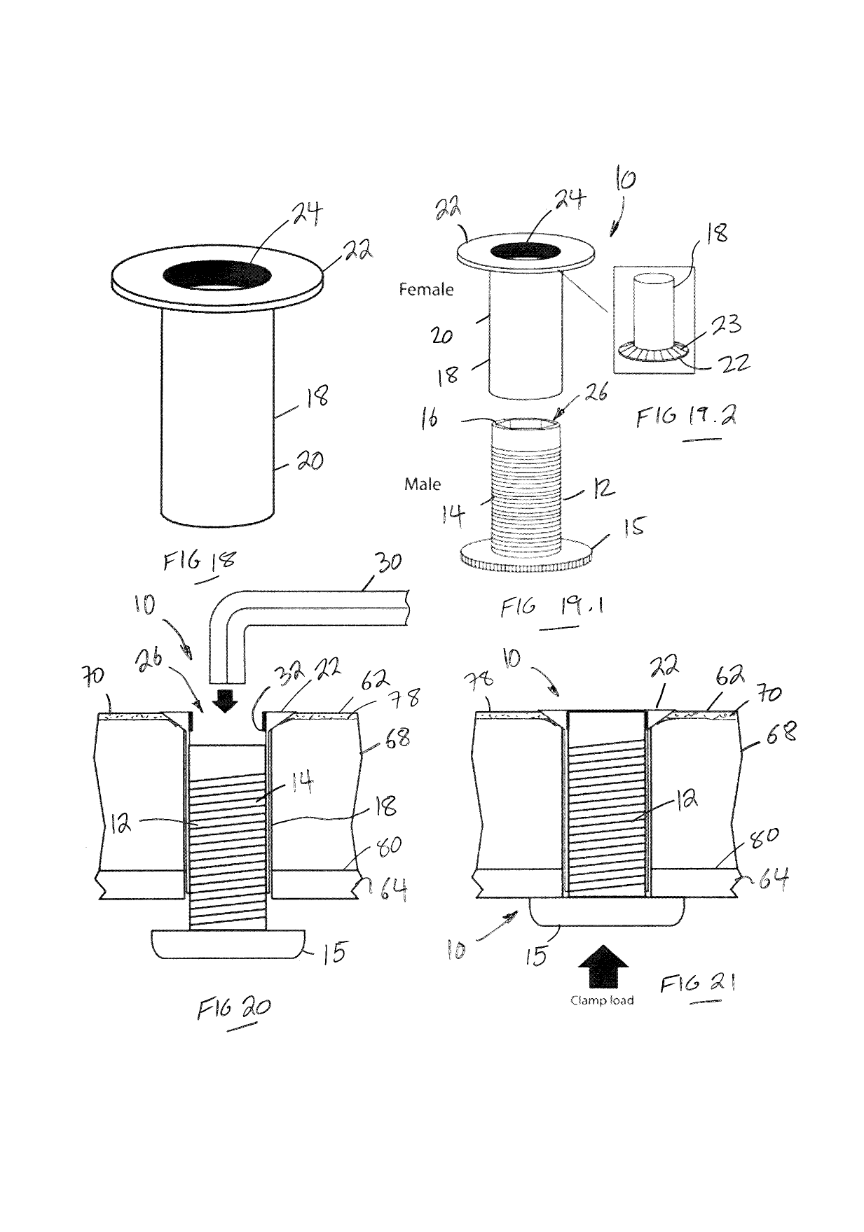

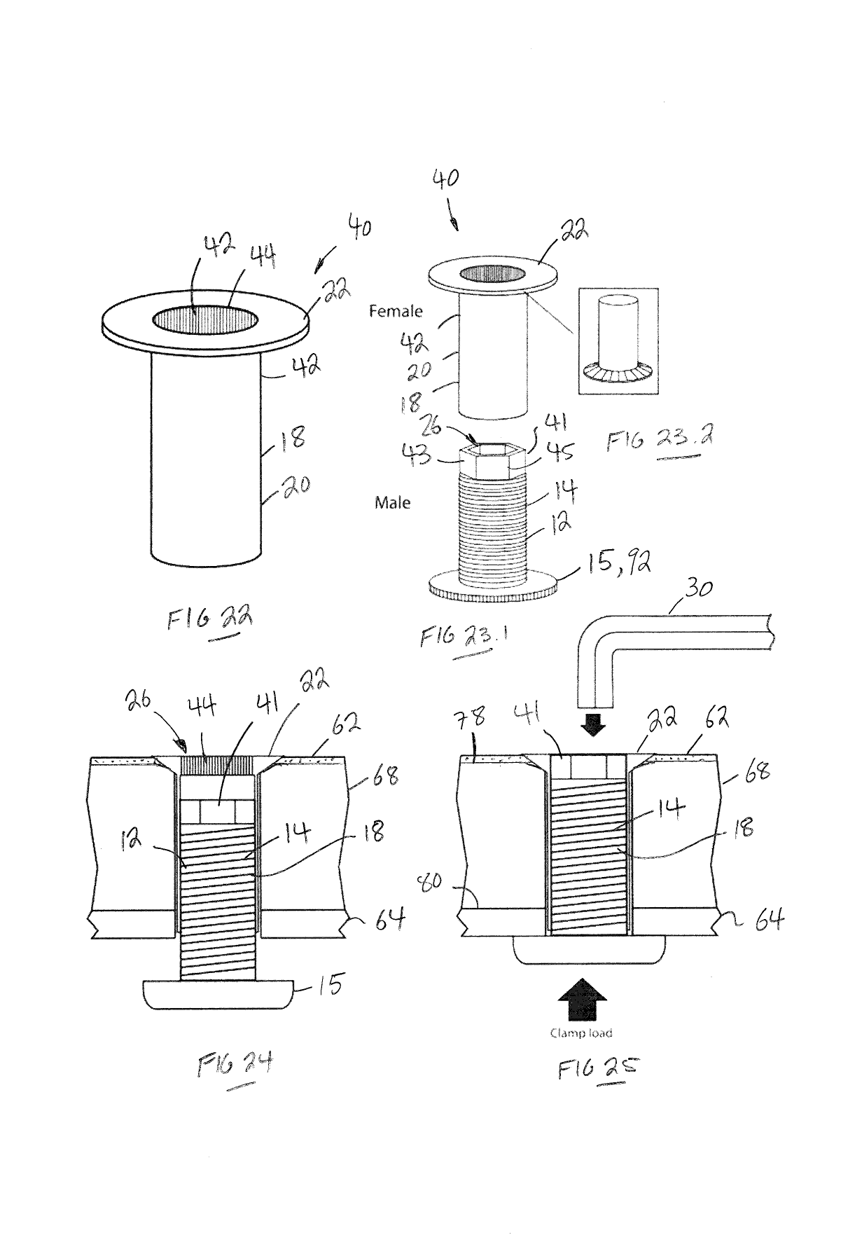

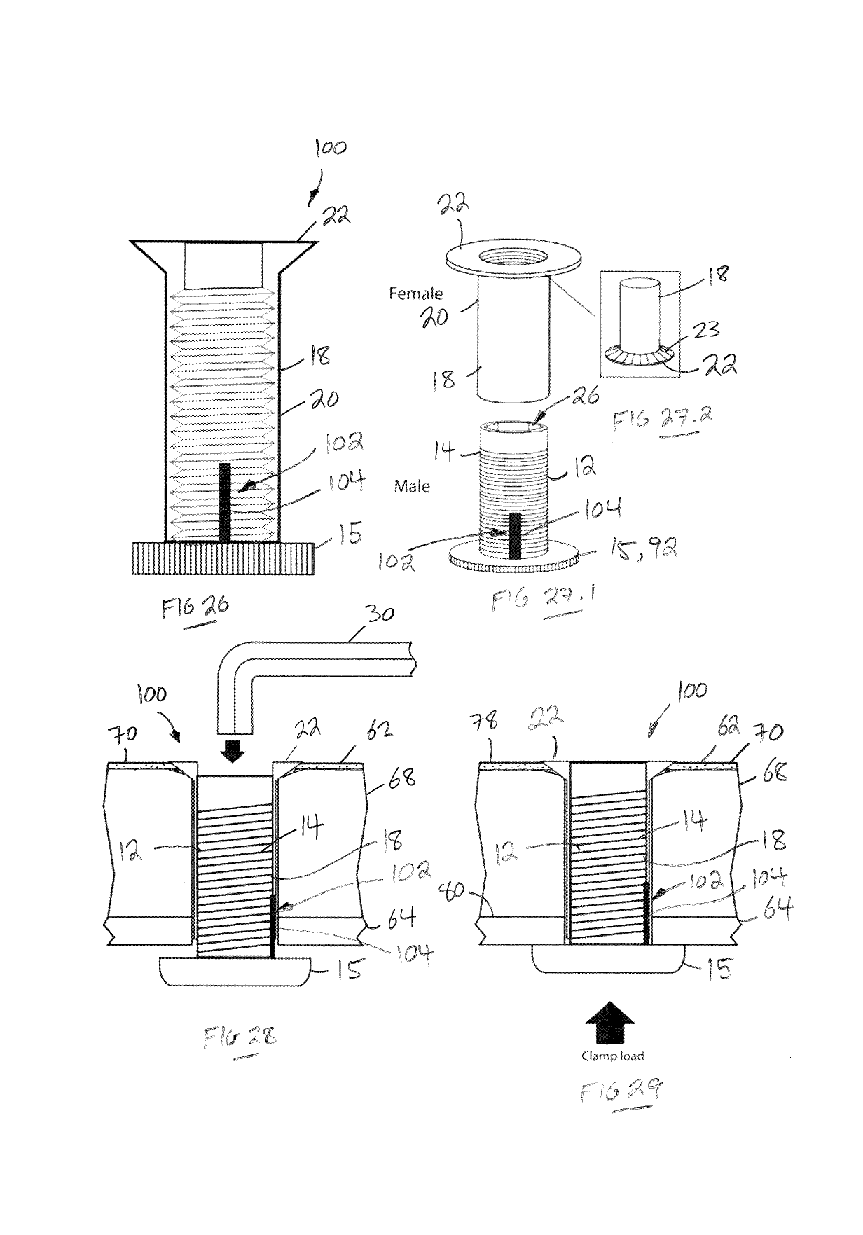

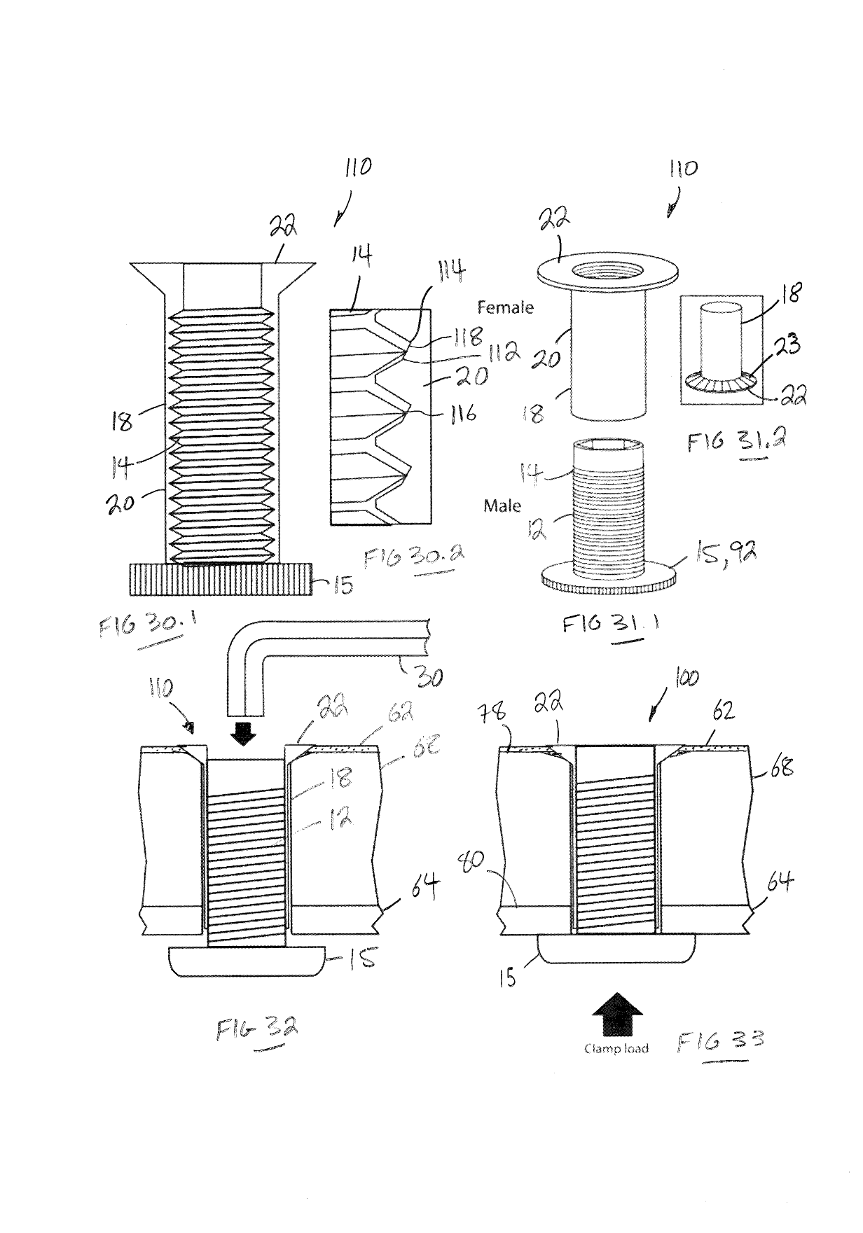

In FIGS. 1, 2 and FIGS. 18 to 21, reference numeral 10 generally indicates a first embodiment of a fastener, in accordance with the invention. The fastener 10 can have a number of different uses. One of the uses for which it is suited, but not limited to, is for fastening a truck to a skateboard deck, as described in further detail below. In this embodiment, the fastener 10 forms part of a deck assembly, in accordance with the invention, for a skateboard.

The fastener 10 includes a male connector 12. The male connector 12 has an externally threaded shank 14. A head 15 is positioned on the distal end of the shank 14 and a tool engaging formation 16 is defined on a proximal end of the shank 14.

In this example the head 15 is disc-shaped and defines a series of axially extending ridges to facilitate a thumb grip. However, it is to be appreciated that the head 15 can take a number of different forms. For example, the head 15 can be relatively thin, as shown in FIG. 19, so that when engaged with a component, its visibility is minimised and there is also minimal protrusion. The inventors envisage that this could be used for skateboard trucks where the minimal protrusion and resultant low profile can enhance the performance of the skateboard, particularly for activities or tricks such as grinding and other manoeuvres. In that example, the head 15 can have a thickness of between 1 mm and 3 mm, preferably 2 mm.

The tool engaging formation 16 is configured so that a tool, such as a key in the form of an Allen or hexagonal (hex) key, a triangular key, or the like, can be used to rotate the male connector 12. In this example, the tool engaging formation is in the form of a socket 26 defined in the proximal end of the shank 14. The socket 26 is shaped so that a key 30 can engage the shank 14. It will readily be appreciated that the socket 26 can be shaped so that a key with a triangular profile can engage the shank 14.

The fastener 10 includes a female connector 18. The female connector 18 defines an internally threaded barrel 20. The barrel 20 is open at both ends. A flange 22 is arranged on a proximal end of the barrel 20.

The male connector 12 can have an overall length of between about 11 mm and 20 mm depending on the thickness of the deck. A constraint is that the male connector 12 does not protrude beyond the proximal end of the female connector 18, in use. The socket 26 can be between about 2 mm and 4 mm deep, for example, about 3 mm deep. The socket 26 is hexagonal or triangular to suit a 2 mm key tool. The shank 14 can have a diameter of between about 3 mm and 5 mm, for example, 4 mm, and an external, right handed thread. The head 15 of the male connector 12 can have a diameter of between about 4 mm and 10 mm, for example 7.5 mm.

The barrel 20 can have an internal diameter to correspond with that of the shank 14. A wall thickness of the barrel 20 can be between about 0.2 mm and 1.2 mm, for example about 0.4 mm.

The flange 22 can have a diameter of between about 5 mm and 10 mm, depending on the diameter of the barrel 20, for example about 7.5 mm.

The male connector 12 and the female connector 18 can be of a suitable metal, such as steel. For example, the connectors 12, 18 can be of a high tensile steel, such as 4140 or 4340 alloy steel.

A thread lock in the form of an insert 24 of locking material is located within the barrel 20 at the proximal end. The locking material is softer than the material of the male connector 12, permitting a proximal portion 28 of the shank 14 to cut into the locking material thereby securing the shank 14 against subsequent un-threading. One example of a suitable locking material is a plastics material such as nylon or similar thread locking material.

It will be appreciated that the head 15 of the male connector 12 and the flange 22 of the female connector 18 can be of similar dimensions to provide a reduced profile when compared with a conventional bolt or screw head.

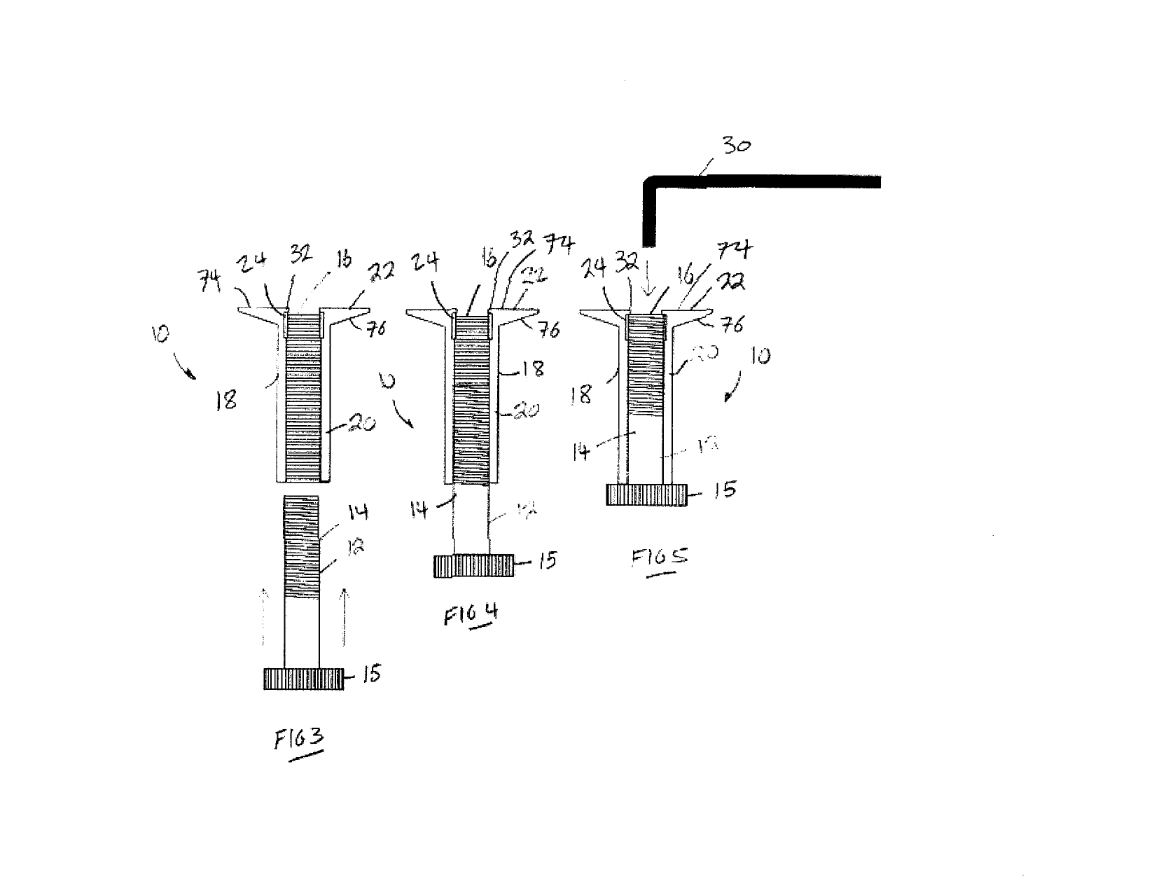

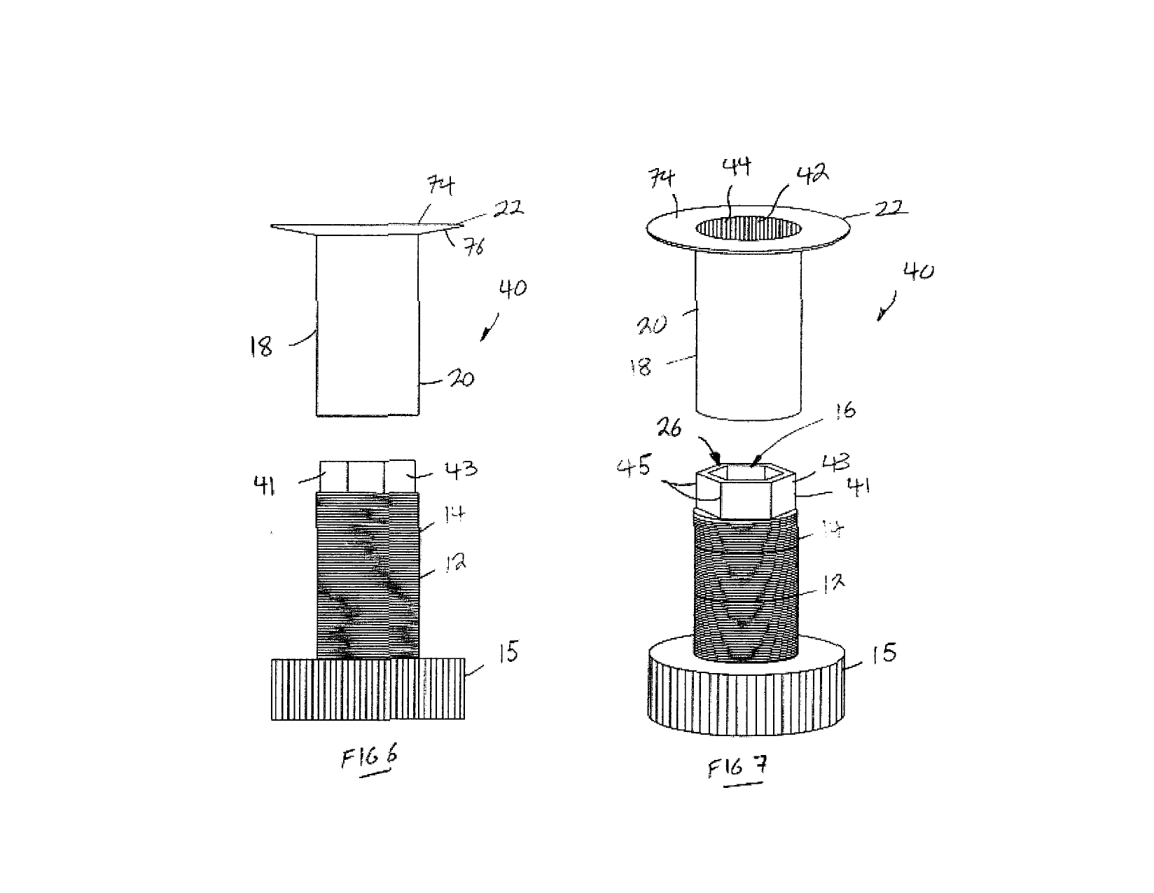

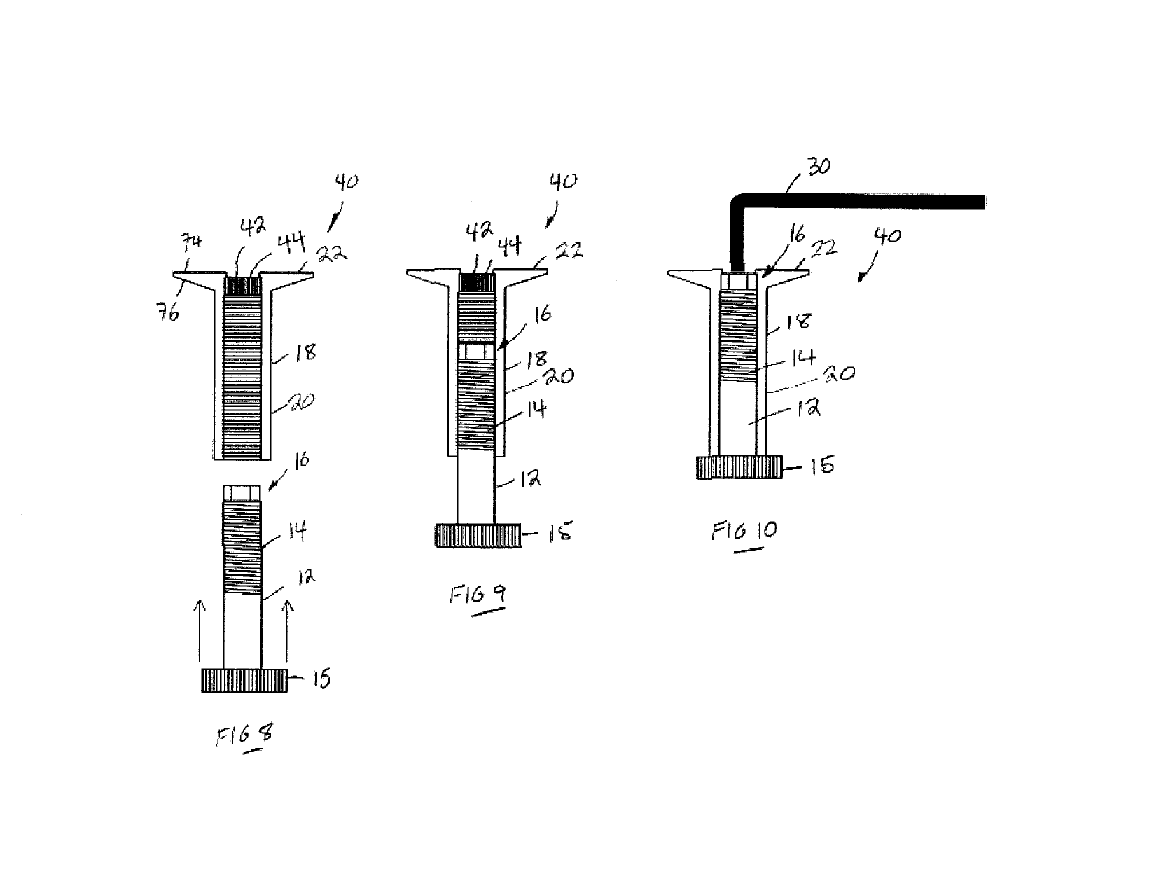

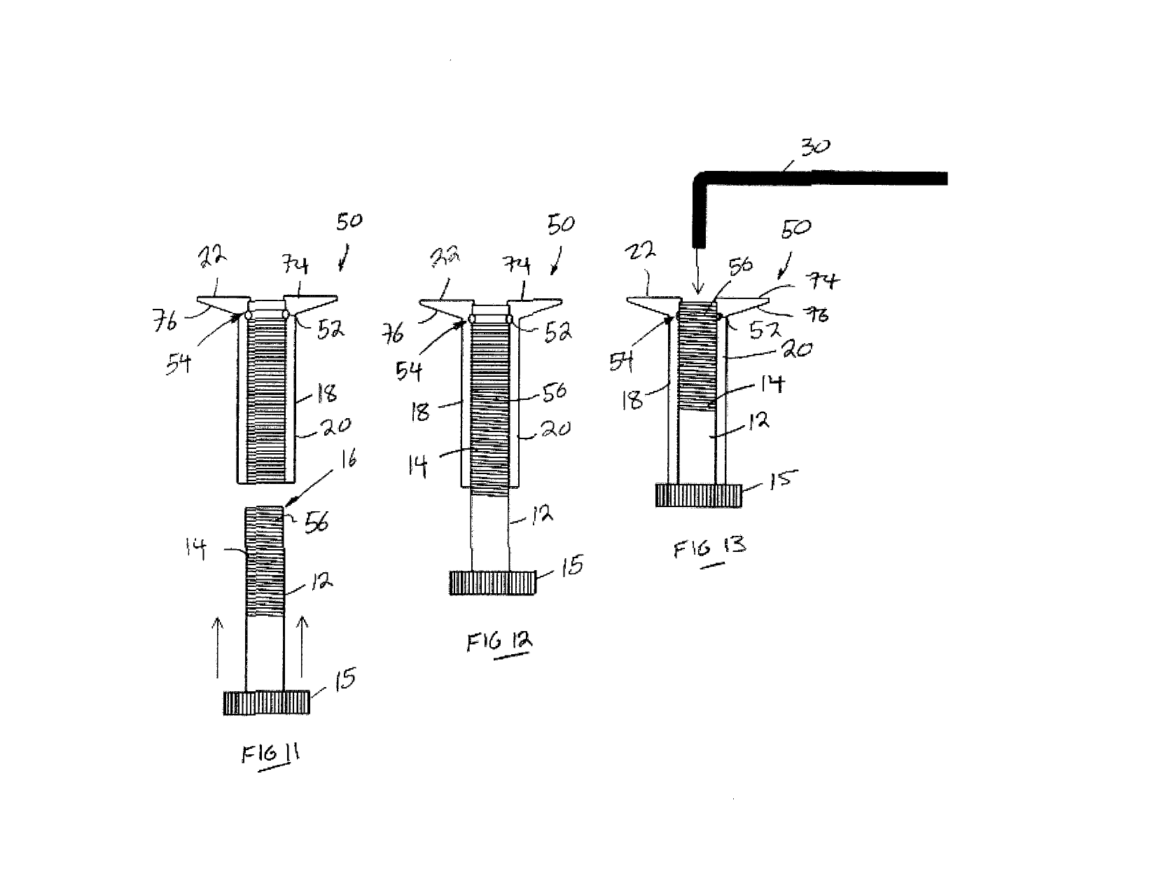

The manner in which the male and female connectors 12, 18 are engaged with each other is shown in FIGS. 3 to 5 and 20, 21. In FIGS. 20, 21 the male and female connectors 12, 18 form part of a deck assembly for a skateboard. As can be seen, the key 30 can access the socket 26 through the barrel 20. Furthermore, the insert 24 is positioned so that as the male connector 12 is threaded into its secured operative condition, the thread of the male connector 12 cuts into the insert 24.

A peripheral lip 32 is defined at the proximal end of the barrel 20 to retain the insert 24 in position, particularly when the shank 14 is screwed into the insert 24. The lip 32 also serves to inhibit over-threading of the male connector 12. Thus, protrusion of the male connector 12 from the female connector 18 is avoided.

As can be seen in FIG. 19.2, an underside of the flange 22 is formed to define knurled grooves 23. As the shank 14 is fastened into the barrel 20, the grooves 23 engage a fastened component, such as a skateboard deck 62 (see below) and secure the barrel 20 against rotation. The grooves 23 can have a maximum depth of about 0.3 mm.

In general, grip tape of a skateboard is first adhered to a core. Openings are then made in the grip tape to allow access to passages in the core for fasteners. Thus, the underside of the flange 22 need not include any grooves or such formations and can generally be smooth. The reason for this is that the grip tape usually contains small, abrasive particles, much like sandpaper. This provides a suitable degree of friction to inhibit rotation of the flange 22 when the male connector 12 is fastened into the female connector 18.

In particular, the flange 22 is shaped so that as the shank 14 is tightened, the flange 22 sinks into a core of the deck 62 such that passages defined in the core become countersunk to accommodate the flange 22. In particular, as the flange 22 sinks into the core of the deck 62, portions of the grip tape are trapped between the flange 22 and the core further serving to inhibit rotation of the flange 22 with respect to the core 62 and the grip tape. Thus, damage to the grip tape is avoided. Also, the flange 22 can be flush with the grip tape thereby enhancing the aesthetic characteristics of the skateboard.

In FIGS. 6 to 10 and 22 to 25, reference numeral 40 generally indicates a second embodiment of a fastener, in accordance with the invention, for use with the deck assembly. With reference to FIGS. 1 to 5 and 18 to 21, like reference numerals refer to like parts, unless otherwise specified.

Instead of the insert 24, the fastener 40 incorporates a metal to metal thread lock. To that end, a proximal internal portion 42 of the barrel 20 defines a series of axially extending ridges 44 extending from an end of the internal thread of the barrel 20 to the proximal end of the barrel 20.

A proximal end portion 41 of the shank 14 is defined by a polygonal wall 43. The wall 43 defines a number of outer corners 45. The wall 43 is dimensioned so that as the male connector 12 is secured to the female connector as shown in FIG. 10, the corners 45 engage the ridges 44 to secure the male connector 12 against subsequent un-threading.

The interaction between the corners 45 and the ridges 44 can take different forms. For example, a resilience of the material of the female connector 44 and the dimensions of the individual ridges 44 can be such that the corners 45 engage the ridges ratchet-fashion. Instead, the material of the female connector 44 and the individual dimensions of the ridges 44 can be such that the ridges 44 are deformed to accommodate the corners 45. The material of the female connector 44 can be such that the deformation results in work-hardening of the ridges 44, further securing the male connector 12 in position.

The wall 43 can be hexagonal so that an inner surface of the wall 43 can engage the key 30 in the form of a hex key. Instead, the wall 43 can be triangular so that an inner surface of the wall 43 can engage the key 30 in the form of a triangular key.

As with the fastener 10, the head 15 of the male connector 12 and the flange 22 of the female connector 18 can be of similar dimensions to provide a reduced profile when compared with a conventional bolt or screw head.

In FIGS. 11 to 13, reference numeral 50 generally indicates a third embodiment of a fastener, in accordance with the invention, for use with the deck assembly. With reference to FIGS. 1 to 10, like reference numerals refer to like parts, unless otherwise specified.

In this example, the thread lock is in the form of an O-ring 52 located in a complimentary circumferential recess or seat 54 at the proximal end of the barrel 20. The position of the seat 54 and the O-ring 52 is such that a proximal portion 56 of the shank 14 deforms the O-ring 52 as the shank 14 is screwed into the barrel 20. The O-ring 52 is dimensioned so that such deformation, in combination with the resilience of the O-ring 52 serves to secure the shank 14 against subsequent un-threading.

The O-ring 52 is of an elastomeric material, such as silicone-rubber, in this particular example.

As with the fastener 10, the head 15 of the male connector 12 and the flange 22 of the female connector 18 can be of similar dimensions to provide a reduced profile when compared with a conventional bolt or screw head.

In FIGS. 14 and 15, reference numeral 90 generally indicates a fourth embodiment of a fastener, in accordance with the invention. With reference to FIGS. 1 to 13, like reference numerals refer to like parts, unless otherwise specified.

The male connector 12 of the fastener 90 has a head in the form of a disc 92 with a profile that is significantly less than the profile of the head 15. For example, the disc 92 has a thickness similar to that of the flange 22. Thus, the fastener 90 can be used in those situations where a minimal amount of protrusion of the fastener from the components is required. This is made possible because the male connector 12 is engaged from within the female connector 18.

External webs or fins 94 are interposed between the barrel 20 and the flange 22. In use, when the male connector 12 is tightened into the female connector 18, the fins 94 dig into one of the components, for example a core of a skateboard deck, to inhibit rotation of the female connector 18.

It is to be appreciated that the male and female connectors 12, 18 can be interchanged, if necessary. Thus, the flange 22 and the associated fins 94 can be positioned on the shank 14 of the male connector 12. Likewise, the head 15 or the disc 92 can be positioned on the barrel 20 of the female connector 18.

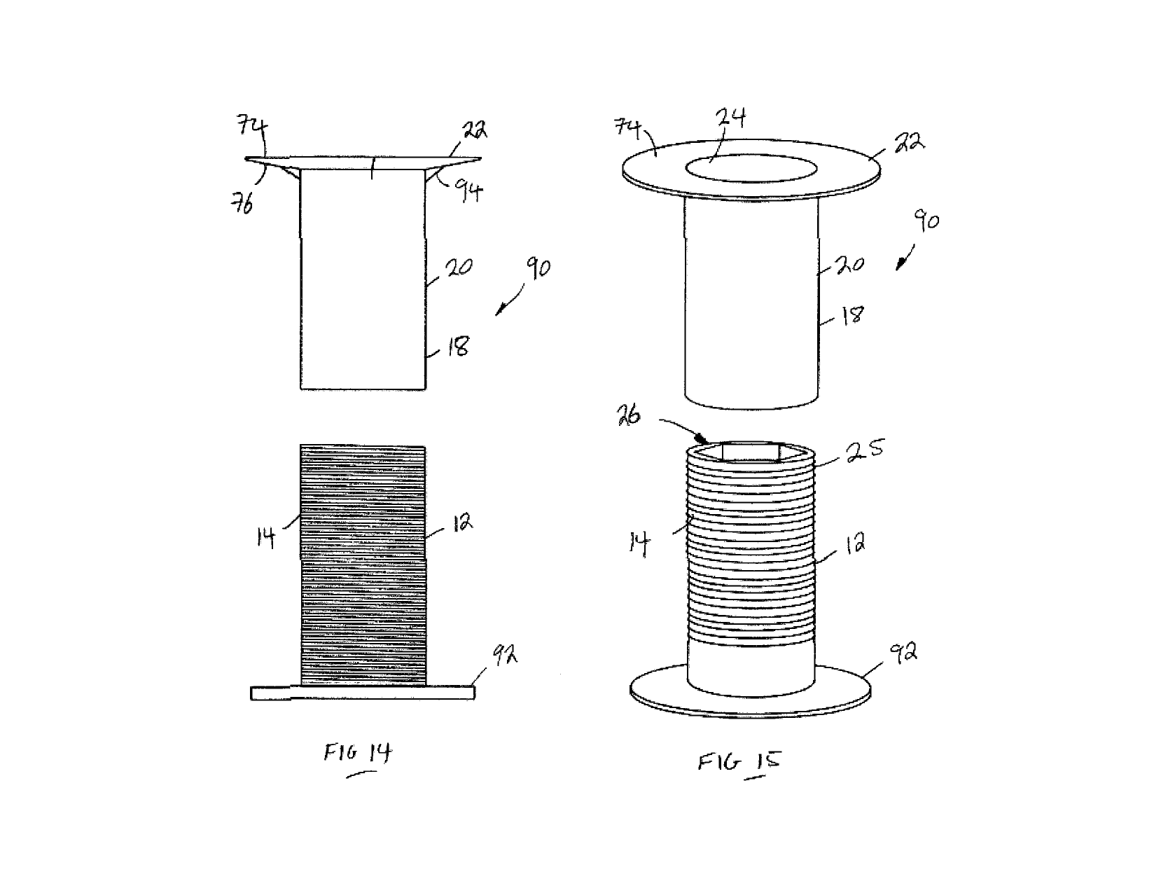

FIGS. 16 and 17 show a deck assembly 61, in accordance with the invention, of a skateboard, making use of the fastener of any of the examples provided above for fastening a truck 60 to a deck 62 of the deck assembly 61. The deck assembly 61 is shown in an exploded condition. It is to be noted that FIGS. 16 and 17 show a front portion of the deck assembly 61 for convenience. The remaining, rear portion is substantially the same as the front portion and so has been omitted for clarity. The omission of the remainder of the deck assembly 61 is not to be construed as a limitation on the claims which are intended to cover either or both the front portion shown and the remainder of the deck assembly 61.

In this example, the truck 60 is of the type having a base plate 64 with four openings 66 to allow the base plate 64 to be fastened to the deck 62 with four of the fasteners.

The deck 62 has a core 68 covered with a layer of grip tape 70. The core 68 defines passages 72 that correspond with the openings 66 in the base plate 64.

Prior to location of the female connectors 18, the grip tape 70 is punched to form openings that correspond to respective passages 72. The female connectors 18 are then inserted into the respective passages 72 along the dotted lines shown in FIG. 16 so that distal surfaces 76 of the flanges 22 bear against portions of the grip tape 70.

The flange 22 has a generally flat proximal surface 74 and the distal surface 76 that tapers from the barrel 20 to a periphery of the proximal surface 74. The shank 14 can be initially tightened by hand. The location of the grip tape 70 between the distal surface 76 and the core 68 serves to provide the necessary friction to inhibit rotation of the flange 22 with respect to the deck 62 during this initial hand-tightening.

Thus, when the shank 14 is tightened with the tool 30, the flange 22 can sink into the core 68 with a portion of the grip tape 70 such that its associated passage 72 becomes countersunk allowing the flange to be flush with the grip tape 70.

It will be appreciated that replacement of the truck 60 will not require any rotation of a fastener relative to the grip tape 70, thus protecting the grip tape 70 from damage.

The inventors envisage that the deck 62 could be supplied with the female connectors 18 mounted in the core 62. For example, the female connectors 18 could be press-fitted or otherwise fastened in the passages 78 of the core 62. Distal portions of the connectors 18 that extend from the deck can then be used conveniently to locate the truck 60 prior to threading the male connectors 12 into the female connectors 18.

The barrels 20 of the female connectors 18 are dimensioned to extend from a lower surface 80 of the core 62 to be received partially in respective openings 66 in the base plate 64. This helps to locate the base plate correctly.

The relative dimensions of the male and female connectors 12, 18 and the location of the thread lock are selected so that the shank 14 of the male connector 12 engages the thread lock as the base plate 64 is secured to the deck 62. Thus, the male connector 12 is secured against subsequent un-threading during use of the skateboard.

The fastener allows a user to fasten the truck 60 to the deck 62 without having to tighten fasteners underneath the deck 62. Furthermore, the fact that the flange 22 engages the grip tape 70 initial rotation is only required of the male connector 12. In other words, at no stage is rotation of the female connector 18 required. With presently used fasteners, it is necessary to rotate a head of a fastener with respect to the grip tape, at least initially. This can result in damage to the grip tape. Also, it is usually necessary to manipulate the fastener from both sides of the deck. This can be inconvenient and time-consuming.

In particular, only one tool is required for replacing the truck 60. With conventional truck assemblies, it is usually necessary to have one tool engage the head of a bolt, while another tool is required to engage a nut that is screwed on to the bolt.

In FIGS. 26 to 29, reference numeral 100 generally indicates a fifth embodiment of a fastener for use with the deck assembly 61. With reference to the preceding drawings, like reference numerals refer to like parts, unless otherwise specified.

The barrel 20 defines a longitudinal slot 102 that extends partially along the shank 14 from the head 15. A strip of locking material 104 is received in the slot to extend radially from the shank 14. As the shank 14 is threaded into the barrel 20, the internal thread of the barrel 20 engages the locking material 104 to secure the shank 14 from unthreading.

In FIGS. 30 to 33, reference numeral 110 generally indicates a sixth embodiment of a fastener for use with the deck assembly 61. With reference to the preceding figures, like reference numerals refer to like parts, unless otherwise specified.

The internal thread of the barrel 20 defines a thread profile with a first apex 112 and a second apex 114, as opposed to just one apex, as with conventional threads. The second apex 114 is cut deeper than the first apex 112. An apex 116 of the thread on the shank 14 initially bears against a ramped portion 118. As the shank 14 is tightened, the apex 116 is driven towards the apex 114 along the ramped portion 118. This has the effect of setting up tension in the shank 14 and barrel 20 so securing the shank 14 against unthreading.

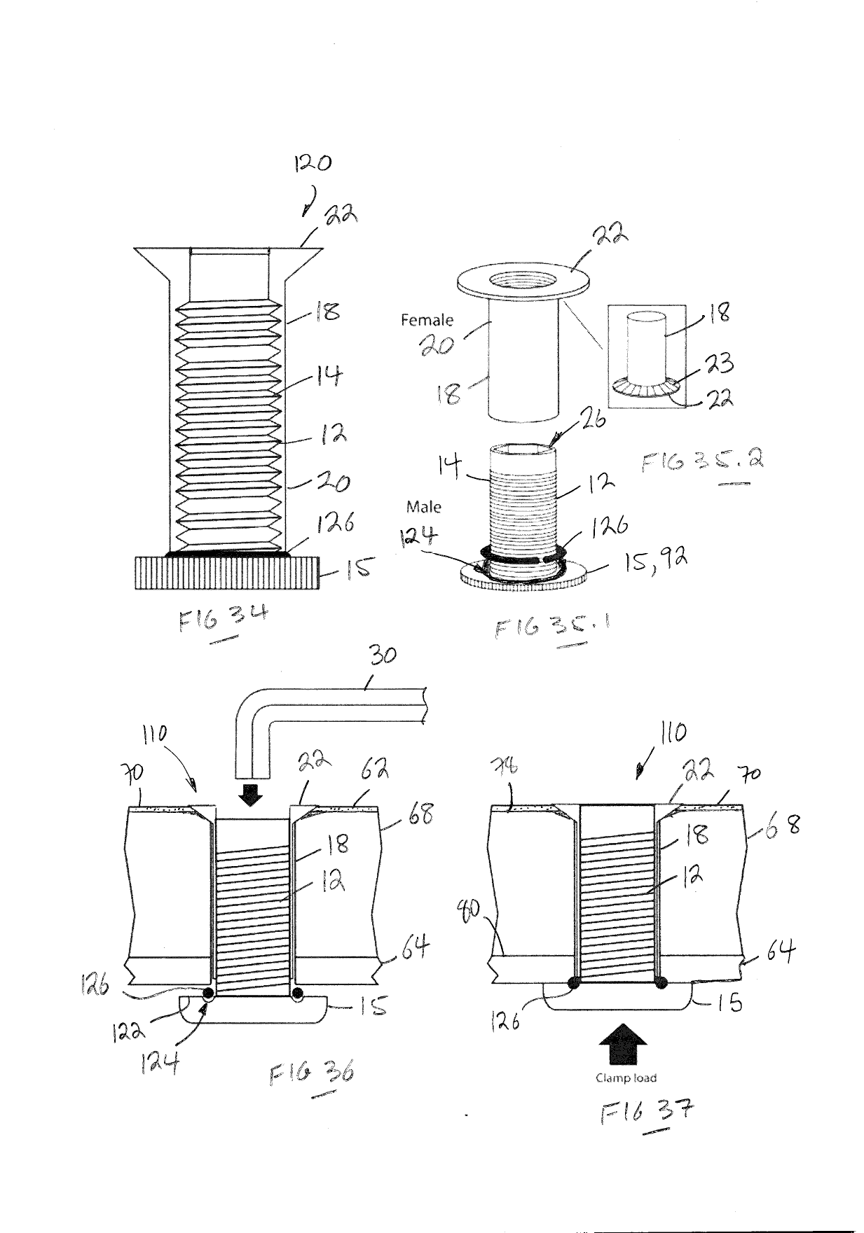

In FIGS. 34 to 37, reference numeral 120 generally indicates a seventh embodiment of a fastener for use with the deck assembly 61. With reference to the preceding figures, like reference numerals refer to like parts, unless otherwise specified.

A bearing surface 122 of the head 15 defines a circular groove 124 at a junction between the head 15 and the shank 14. An O-ring 126 is received over the shank 14 to be positioned on the groove 124. The O-ring 126 is slightly larger than the groove 124. The O-ring 126 is of an elastomeric or deformable material. Thus, when the shank 14 is tightened, a portion of the O-ring seats in the groove 124 and a portion is urged between the threads of the shank 12 and barrel 20, as shown in FIG. 36. The O-ring 126 can thus inhibit unthreading of the shank 12 from the barrel 20.

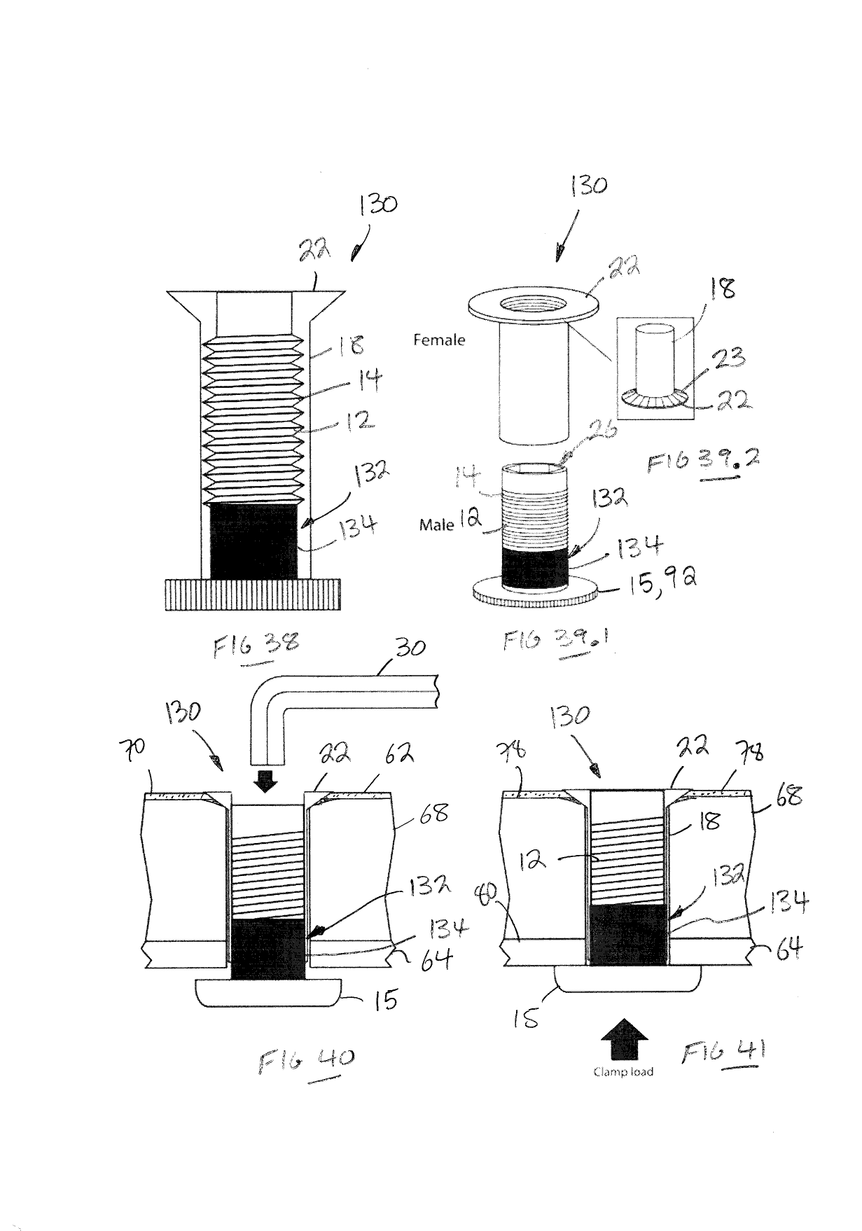

In FIGS. 38 to 41, reference numeral 130 generally indicates an eighth embodiment of a fastener for use with the deck assembly 61. With reference to the preceding figures, like reference numerals refer to like parts unless otherwise specified.

A distal portion of the shank 14 defines a circumferential recess 132. A band 134 of locking material is received in the recess 132. Thus, when the barrel 20 engages the shank 14, the internal thread of the barrel 20 cuts into or deforms the band 134, serving to lock the barrel 20 with respect to the shank 14.

The inventors envisage that the fasteners can be used with forms of trucks that are different from the truck shown in the drawings. For example, there may be a clamping arrangement that is used to clamp the truck to the deck. In that case, the fasteners could engage the clamping mechanism. In another example, the truck could be mounted on a guide or rail, which itself is fastened to the deck with the fasteners.

As is known, a large number of tricks and manoeuvres are performed by skateboard riders. These can often involve the truck 60 sliding over various objects. It can be desirable that a surface of the base plate 64 provides minimal obstruction for such manoeuvres. For that purpose, the fastener 90 can be particularly suited. It will be appreciated that the disc 92 can be seated substantially flush against the base plate 64 to provide such minimal obstruction.

Furthermore, use of the fastener 90 can be regarded as enhancing the aesthetic appeal of the truck 60 when it is fastened to the deck 62.

Also, the combination of the disc 92 and the flange 22 allows for the relative positions and functions of the male and female connectors 12, 18 to be interchanged, if necessary.

It is to be appreciated that when the truck 60 is fastened to the deck 62, it is not necessary to rotate the female connector 18 (or the male connector 12 if that is the connector positioned in the deck 62). Thus, the grip tape 70 is protected from damage which may result when a conventional fastener is accessed from an upper side of the deck 62 and rotated. Thus, the grip tape 70 is also protected whenever a user decides to change the truck 60.

It is envisaged by the inventors that the invention extends to a truck with a base plate that is shaped to accommodate the head 15 or the disc 92 or, where required, the flange 22.

In the specification and claims:
a. The word “proximal” is used to describe a side from which a tool would be used to engage the male connector. The word “distal” is thus used to describe the opposite side.
b. The words “thread lock” are used to describe any material or configuration of threads or any components or any other means that can be used to achieve a locking effect between components that are threaded together.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

1. A deck assembly for a skateboard, the deck assembly comprising:
a deck that defines a pair of sets of passages corresponding with openings in mounting structures used for mounting trucks to the deck;
a number of male connectors corresponding with respective passages and openings, each male connector having an externally threaded shank, a head on a distal end of the shank and a tool engaging formation defined on a proximal end of the shank; and
a number of female connectors also corresponding with respective passages and openings, each female connector defining an internally threaded barrel, open at both ends, and a flange on a proximal end of the barrel, the shank being configured for threaded engagement with the barrel, using a tool that engages the formation through the female connector, the female connectors being received through the passages and openings such that the heads of the female connectors bear against the deck and the male connectors being received through the openings and into the passages to engage respective barrels such that the tool engaging formations can be accessed from an operatively upper side of the deck allowing the mounting structures to be secured to the deck from said upper side.

2. A deck assembly as claimed in claim 1, in which a thread lock is arranged on at least one of the barrel and the shank to lock the barrel and shank together when the male and female connectors are fastened together.

3. A deck assembly as claimed in claim 1, in which a layer of grip tape is positioned on the deck so that, as the male and female connectors are fastened together, a portion of the grip tape is interposed between the flange of the female connector and the deck.

4. A deck assembly as claimed in claim 2, in which the thread lock is in the form of an insert of a locking material positioned on an internal surface of the barrel at the proximal end, the locking material being softer than the material of the male connector, permitting a proximal portion of the thread of the shank to cut into the locking material, thereby securing the shank against subsequent un-threading.

5. A deck assembly as claimed in claim 2, in which the thread lock is a strip of locking material arranged about the shank of the male connector, proximate the head of the male connector so that, as the shank screwed into the barrel, the thread in the barrel can engage the locking material to lock the shank in the barrel.

6. A deck assembly as claimed in claim 2, in which the thread lock is an O ring located at the proximal end of the barrel, the barrel defining a circumferential recess in which the O ring is located and the recess and corresponding O-ring are such that a proximal portion of the shank deforms the O-ring as the shank is screwed into the barrel, the O-ring being dimensioned so that the deformation combined with the resilience of the O-ring serves to secure the shank against subsequent un-threading.

7. A deck assembly as claimed in claim 2, in which the locking means is in the form of a series of axially extending ridges extending from an end of the internal thread of the barrel to the proximal end of the barrel, the shank of the male connector defining a proximal portion that is un-threaded and that is configured to interfere with the ridges as the shank is secured to the barrel, the ridges being configured so that as the proximal portion of the shank passes beyond the internal thread of the barrel, the proximal portion engages the ridges to retain the shank in position and to secure the shank against subsequent un-threading.

8. A deck assembly as claimed in claim 2, in which the internal thread of the barrel has a profile that defines a ramped surface between a pair of apices, one deeper than the other so that an apex of the male thread initially bears against the ramped surface before being driven towards the deeper apex as the shank is tightened so locking the shank in the barrel.

9. A deck assembly as claimed in claim 3, which includes a core that defines the passages, the core being of a material that is softer than that of the female connector, the flange of the female connector tapering outwardly towards a proximal end such that when the shank of the male connector is tightened into the barrel of the female connector, the flange, with a portion of the grip tape, sinks into the core such that the associated passage becomes counter-sunk.

10. A deck assembly as claimed in claim 9, in which a tapered surface of the flange includes at least one gripping formation to engage the core to inhibit rotation of the female connector when the male connector is tightened into the barrel of the female connector.

11. A deck assembly as claimed in claim 1, in which the head of the male connector has a thickness of between approximately 1 mm and 3 mm so as to define a suitably low profile to minimise interference of the mounting structure with surfaces on which the skateboard is used.

12. A deck assembly as claimed in claim 1, in which the mounting structures are in the form of base plates, each base plate having a number of openings to allow the base plate to be fastened to the deck with a corresponding number of the male and female connectors.

13. A deck assembly as claimed in claim 12, in which the barrels of the female connectors are dimensioned so that when they are positioned in the passages, they extend from a lower surface of the deck to be received partially in respective openings in the base plate, so serving to locate the base plates correctly prior to engagement of the male connectors with the female connectors.

14. A method of assembling a skateboard, the method comprising the steps of:
positioning barrels of each of a number of female connectors in respective passages defined in a deck of the skateboard, each barrel being internally threaded, open at both ends and having a flange on a proximal end of the barrel;
positioning externally threaded shanks of each of a number of corresponding male connectors in openings in mounting structures used for mounting trucks to the deck, the shanks being configured for threaded engagement with respective barrels and having tool engaging formations defined on their proximal ends and heads on their distal ends to engage operatively lower surfaces of the mounting structures; and
fastening the mounting structures to the deck by threading the male connectors onto the female connectors with a tool that accesses the tool engaging formations from a proximal end of the female connectors.

15. A method as claimed in claim 14, in which the deck of the skateboard includes a layer of grip tape positioned on a core of the deck, the method including the steps of punching openings in the grip tape corresponding with the respective passages and inserting the barrels into the passages so that portions of the grip tape are interposed between the flanges and the core.

16. A fastener for use with a deck assembly of a skateboard, the fastener comprising
a male connector having an externally threaded shank, a head on a distal end of the shank and a tool engaging formation defined on a proximal end of the shank, the male connector capable of being received through an opening defined in a mounting structure for mounting a truck to a deck of the skateboard with the head engaging an operatively lower surface of the mounting structure; and
a female connector defining an internally threaded barrel that is capable of being received in a passage defined in the deck and corresponding to the opening in the mounting structure, the barrel being open at both ends, and a flange being positioned on a proximal end of the barrel, the shank being configured for threaded engagement with the barrel, using a tool that engages the formation through the female connector.
